(19) United States
(12) Patent Application Publication
(10) Pub. No.: US 2004/0049442 A1
(43) Pub. Date: Mar. 11, 2004

(54) Method for converting sums of money

(76) Inventor: Leif Lundblad, Stockholm (SE)

Correspondence Address: JACOBSON HOLMAN PLLC, 400 SEVENTH STREET N.W., SUITE 600, WASHINGTON, DC, 20004, US

(21) Appl. No.: 10/363,862

(22) PCT Filed: Sep. 7, 2001
(86) PCT No.: PCT/SE01/01916

(30) Foreign Application Priority Data
Sep. 27, 2000 (SE) 0003456-1

(51) Int. Cl. G06F 17/60

(52) U.S. Cl. 705/35

(57) ABSTRACT

A method of converting a sum of money involving the commencement or the cessation of interest calculations on the sum concerned comprises the steps in which a customer deposits in a banknote machine (121) a number of banknotes whose value corresponds to a given sum; and subsequent to determining the value of the banknotes and checking the authenticity of the banknotes, the banknote machine (121) automatically credits the sum to the customer's account with a given bank (12), and transfers the sum electronically to the account of the bank (12) with a superordinate bank (1, the Bank of Sweden), and said sum is credited to a corresponding internal account belonging to the bank (12); or comprising the steps where a customer takes from a banknote machine (121) a number of banknotes corresponding in value to a given sum; and wherein the banknote machine (121) automatically debits the sum from the customer's account with a given bank (12) and electronically subtracts said sum from the account of the bank (12) with the superordinate bank (1, The Bank of Sweden) and debits the corresponding internal account of the bank (12) for the sum involved.

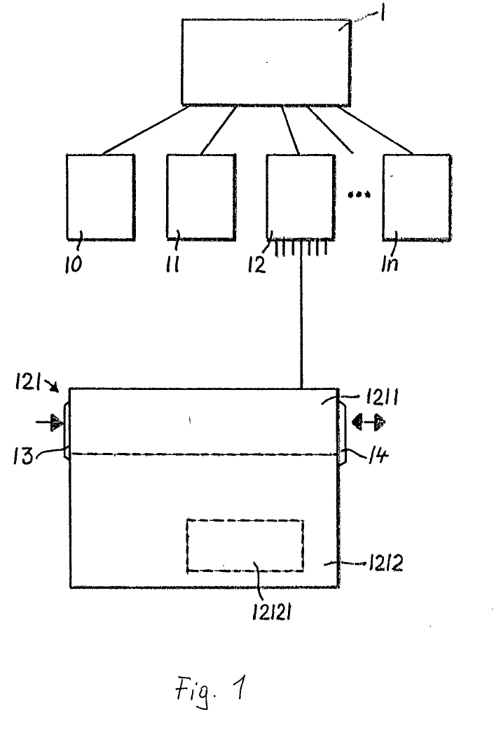

### FIELD OF INVENTION AND BACKGROUND ART

The present invention relates to a method of converting sums of money. By conversion as used in this document is meant the commienceinent or the cessation of interest calculations.

As has earlier been mentioned in different contexts, the handling of the quantity of banknotes circulating commercially is highly time-consuming and labour consuming in practice, and therefore very expensive. Banknotes circulating in commerce, for instance, are deposited in banks where they are counted and checked. These banknotes are then transferred to a banknote collection centre at which they are again counted and checked. The banknotes are finally lodged at depots associated with the Bank of Sweden, where they are again counted and subjected to authenticity checks under adequate security. Conversion is not carried out until the banknotes are deposited in the depots of the Bank of Sweden. It has been estimated that the cost of handling cash in Sweden using present-day technology is around 11 billion SEK. The Bank of Sweden is responsible for removing from circulation banknotes of poor quality (dirty, wrinkled, torn banknotes) and safely destroying such banknotes, i.e. so that banknotes that have once been deemed to be genuine are truly destroyed (burned) and are not illegally smuggled into circulation again. The same applies, of course, to forged banknotes; a banknote which has deemed to be a forgery must be taken out of general circulation immediately and treated in a secure fashion.

At present, this procedure involves, of necessity, several check counts of banknote bundles, registration and transportation. Development work towards a more decentralised but equally as secure banknote handling procedure is ongoing at present, and the inventive method of conversion is an element of this development work.

### SUMMARY OF THE INVENTION

The method of converting sums of money in accordance with the invention involves the owner of a sum of money (bank client) depositing a number of banknotes in a banknote machine to a value corresponding to said sum, wherein, after determining the value and the authenticity of the deposited banknotes, the banknote machine credits said sum to the client's account in a predetermined bank, and said sum is sent electronically to the client's account in the bank account of a superordinate or governing bank (the Bank of Sweden), wherein the corresponding internal account of said bank is credited said sum at the same time. The conversion has now been carried out and the sum and the banknotes have been transferred to the ownership of the superordinate bank and the banknotes are locked in the banknote machine and are under the control of the superordinate bank and within its decentralised domain in the banknote storage magazine (12121) of the machine (121). The calculation of interest with respect to said sum ceases herewith.

If, instead, the owner of a sum of money (bank client) takes from the banknote machine a number of banknotes whose value corresponds to said sum, there is followed a corresponding, as will be apparent from the accompanying claim 2. The banknote machine will then debit the aforesaid sum from the client's account in a predetermined bank and electronically subtract the sum from the bank account of the superordinate bank (the Bank of Sweden), wherewith the corresponding internal account of the bank will be debited the sum involved at the same time. The conversion has now been carried out and said sum has been transferred to the ownership of the bank and the banknotes have been transferred from the decentralised domain from the superordinate bank (1) into a magazine (12121) for storage of banknotes in the machine (121) and into the ownership of the client. Calculation of interest on said sum therewith commences.

The invention will now be described in more detail with reference to the accompanying drawing, which illustrates schematically a practical application of the inventive method.

A banknote depositing and dispensing machine 121 includes a processing part 1211 that has means for determining the denomination of the banknotes deposited and means for checking the authenticity and the quality of said banknotes, and a strongbox part 1212 which includes a magazine 12121 for storing banknotes, either mixed or in accordance with denomination. The processing part of the machine is connected to a bank 12, either by means of cables or in a wireless fashion, wherein the bank 12 has connections to a superordinate bank 1, the Bank of Sweden in the case of Swedish applications. Quality sorting of the banknotes is also decentralised, which, in principle, is a requirement for obviating the transportation of banknotes to the superordinate bank for quality sorting and concurrent conversion. The machine is operated via respective panels 13 and 14 for depositing banknotes and depositing and dispensing banknotes respectively.

A plurality of banknote machines of principally the same kind as that described are similarly connected to the bank 12.

A number of banks 10, 11, . . . 1n are similarly connected to the superordinate bank 1, either by cable or in a wireless manner, and have similar banknote machines connected thereto.

1. A method for the conversion of sums of money, characterised in that
the owner of said sum of money, a bank client, deposits in a banknote machine (121) a number of banknotes corresponding in value to said sum;
in that subsequent to determining the value and the authenticity of the deposited banknotes, said banknote machine credits said sum to the client's account in a predetermined bank (12); and
in that said sum is transferred electronically to the bank's account with a superordinate bank (1, the Bank of Sweden), wherewith the corresponding internal account of said bank (12) is credited with said sum at the same time;
wherewith the conversion is carried out, i.e. calculation of the interest on said sum ceases,
and wherewith said sum and the banknotes are transferred to the possession of the superordinate bank (1) and the banknotes are locked in a magazine (12121) for storage of banknotes in the banknote machine (121) and are under the control of the superordinate bank (1) within its decentralised domain, in the magazine (12121) of the machine (121).

2. A method for the conversion of a sum of money, characterised in that
an owner of said sum of money, a bank client, takes from a banknote machine (121) a number of banknotes corresponding in value to said sum;
in that the banknote machine (121) debits said sum from the client's account in a predetermined bank (12); and
in that said sum is taken electronically from the bank's (12) account with a superordinate bank (1, the Bank of Sweden), wherewith the corresponding internal account of the bank (12) is debited said sum at the same time;
whereby said conversion is carried out, i.e. calculation of interest on the sum commences,
and said sum is transferred to the ownership of the bank (12) and the banknotes are tnansferred from the decentralised domain of the superordinate bank (1) in a magazine (12121) for storage of banknotes in said machine (121), to the ownership of the client.
